(19) United States
(12) Patent Application Publication
(10) Pub. No.: US 2012/0271762 A1
(43) Pub. Date: Oct. 25, 2012

(54) METHOD AND SYSTEM TO FACILITATE A TRANSFER OF FUNDS BETWEEN PARTIES USING A TELEPHONE-ENABLED DEVICE

(75) Inventors: 94303 Freeland, Palo Alto, CA (US); Franck Chastagnol, Redwood City, CA (US); Hugo Olliphant, San Francisco, CA (US); Celine Martig, London (GB); Thomas Belousek, Howth (IE); Bharathi Ramavarjula, San Jose, CA (US); Alex Khomenko, Stanford, CA (US); Kenneth Kang, San Jose, CA (US)

(73) Assignee: eBay Inc., San Jose, CA (US)

(21) Appl. No.: 13/543,245

(22) Filed: Jul. 6, 2012

Related U.S. Application Data
(63) Continuation of application No. 10/910,041, filed on Aug. 2, 2004.

(51) Int. Cl. G06Q 20/10

(52) U.S. Cl. 705/39

(57) ABSTRACT

A method and system utilized to receive a registration request to register a mobile telephone with a financial payment system and contact information that identifies the mobile telephone. The system generates a confirmation code responsive to receiving the contact information and communicates the confirmation code to the mobile telephone. The system further receives from the mobile telephone a request to confirm the registration, the request to confirm registration including the confirmation code; and configures the first financial account at the financial payment system to receive instructions from the mobile telephone to transfer funds on the financial payment system.

### RELATED APPLICATIONS

This application is a continuation of U.S. Utility application Ser. No. 10/910,041, filed Aug. 2, 2004 which is incorporated herein by reference.

### TECHNICAL FIELD

Exemplary embodiments of the present invention relates generally to the technical field of electronic funds transfers and, in one exemplary embodiment, to methods and systems to facilitate a transfer of funds between parties using a telephone-enabled device.

### BACKGROUND

For centuries, buyers and sellers have exchanged goods and/or services in return for monetary payment using legal tender such as coins, paper currency, and promissory notes (e.g., checks). However, such transactions required the consumer to physically carry the legal tender with them risking the total loss of the funds if stolen.

Many consumers today are able to make an electronic purchase over a computer network, such as over the Internet via the World Wide Web. For example, a consumer may use a web browser to purchase an item using a credit card or a debit card number to facilitate the transfer of funds from a credit card account or a personal checking account to a financial account of a merchant. However, there are some disadvantages of such electronic transactions to the consumer, such as not being able to first physically inspect the item (e.g., the consumer is unable to touch, smell, view, taste, listen, etc., the item).

In another scenario, a consumer may purchase an item by swiping a credit card at a merchant cash register terminal to facilitate the transfer of funds from a financial account of the consumer to a financial account of the merchant. However, such cash register terminals require the merchant to obtain an agreement with the issuer of the credit card to connect to the network maintained by the credit card issuer to facilitate the transfer of funds. Also, the merchant, specifically one of a small/medium size business, might find the cost to purchase, install, and maintain numerous hardware and software devices to facilitate such funds transfers to be too prohibitive.

Furthermore, depending on the circumstances, some financial transactions are more suitable to be performed electronically, while others are more suitable for legal tender. For example, a transaction involving a relatively small amount of money between two individuals is typically performed using paper currency. In addition, some merchants do not allow consumers to make a purchase using a credit card, if the transaction is below a specific dollar amount. This is because the purchase amount might be less than a transaction fee the merchant might receive from the issuer of the credit card. Thus, an individual must carry both legal tender and a credit card to be confident in their ability to perform a financial transaction.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary system according to one exemplary embodiment of the present invention, to perform a transfer of funds using a telephone-enabled device;

FIG. 2 illustrates one exemplary embodiment of a data structure;

FIG. 3 illustrates one embodiment of an exemplary registration process flow for configuring the payment system to facilitate a transfer of funds from one or more financial accounts associated with a user using a telephone-enabled device;

FIG. 4 illustrates one embodiment of a Phone Registration Form that may be used to collect contact information to register a mobile telephone to be used by the user to facilitate a transfer of funds;

FIG. 5 illustrates one embodiment of an exemplary Phone Registration Confirmation Form;

FIG. 6 illustrates one embodiment of a process flow for facilitating a funds transfer between parties using a telephone-enabled device;

FIG. 7 illustrates an exemplary view of the client device that might be used to request a funds transfer;

FIG. 8 is a network diagram depicting an alternative system, according to another exemplary embodiment of the present invention;

FIG. 9 is a block diagram illustrating multiple marketplace and payment applications that, in one exemplary embodiment of the present invention, are provided as part of the network-based marketplace;

FIG. 10 is a high-level entity-relationship diagram, illustrating various tables that may be maintained within the databases, and that are utilized by and support the marketplace and payment applications; and

FIG. 11 illustrates an exemplary embodiment of a process flow for performing a transfer of funds upon a completion of a network-based transaction.

### DETAILED DESCRIPTION

A method and system to facilitate a transfer of funds between parties using telephone-enabled device are described. In the following description, for purposes of explanation, numerous specific details are set forth in order to provide a thorough understanding of the present invention. It will be evident, however, to one skilled in the art that the present invention may be practiced without these specific details.

According to one aspect of the invention, a funds transfer module receives a request from a first party using a telephone-enabled device to transfer funds to a financial account associated with a second party. According to another aspect of the invention, a funds transfer is performed from a first financial account to a second financial account upon receiving a transaction identifier related to a transaction between a first party and a second party via a telephone-enabled device.

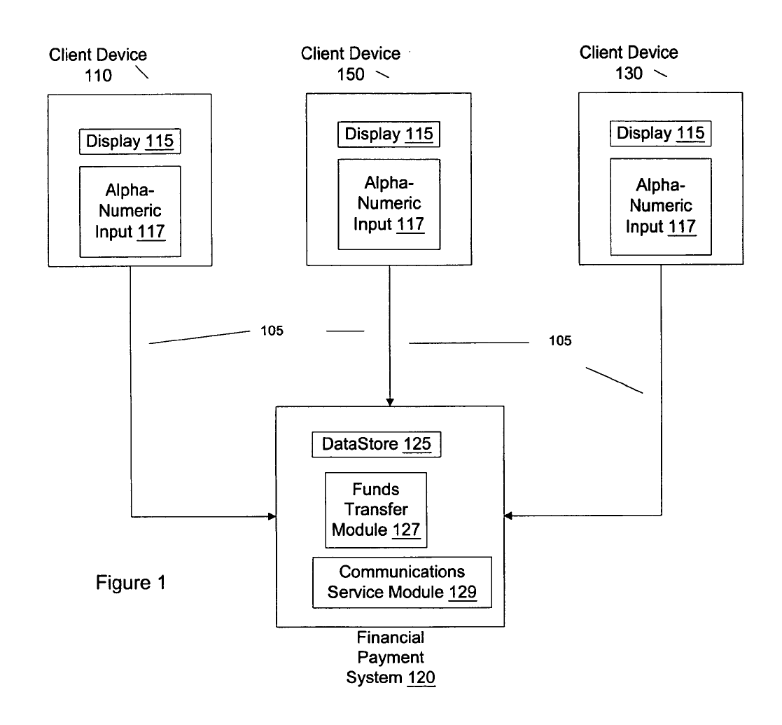

FIG. 1 illustrates a system 100, according to one exemplary embodiment of the present invention, to perform a transfer of funds using a telephone-enabled device. The system 100 includes a client telephone-enabled devices 110, 130, and 150, and a financial payment system 120 connected via a communications network 105. In one embodiment, each client device (110, 130, 150) includes a user display 115 and an alpha numeric input device 117 (e.g., a touch pad, a keyboard, etc).

The client telephone-enabled devices (110, 130, 150) may each be a device capable of facilitating communications between parties using a telephone communications network (e.g., the POTS network, a VoIP network, a mobile telephone network etc.), and be a conventional telephone device, a mobile telephone, a personal digital assistant (PDA), a tablet PC, and a personal computer among other devices well known to those of ordinary skill in the art capable of executing a set of instructions (sequential or otherwise) that specify actions to be taken by that machine.

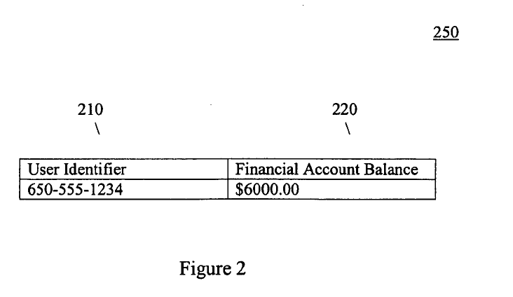

The financial payment system 120 includes, at least, a datastore 125, a funds transfer module 127, and a communications service module 129. Furthermore, the datastore 125 may store data within a financial data structure 250 according to one exemplary embodiment as illustrated in FIG. 2.

The financial account data structure 250 includes financial account information related to a user. The financial account data structure 250 includes a user identifier field 210, and the user account balance amount field 220. It is understood that the data structure 250 is not limited to the fields disclosed in FIG. 2. Rather, one of ordinary skill in the art will recognize that additional fields may be used that are not described herein such as additional user information and spending limits associated with the user. Therefore, it is also understood that information stored in the financial account data structure 250 is only exemplary so as to not obscure this detail description.

The funds transfer module 127 enables the transfer of funds from a financial account associated with a first party to a second financial account associated with a second party. For example, upon completing a sales transaction between the first party and the second party, the funds transfer module 127 may facilitate a transfer of funds from the financial account of the first party to the financial account of the second party upon receiving authorization from the first party via the client devices 110, 130 and 150.

The communications service module 129 enables the financial payment system 120 to receive and transmit information with the client devices (110, 130, 150). For example, the communication service module 129 may include a short message service (SMS) gateway, a dual-tone multi-frequency (DTMF) service, a voice recognition service, and/or an instant messaging service, among other examples of protocol that facilitates communication which may be used to perform the methods described herein. For instance, SMS is a service available on most digital mobile phones that permits the sending of short messages (e.g., text messages) between mobile phones and other handheld devices. The communications service module 129 may enable the financial payment system 120 using SMS to receive instructions from a user of an SMS-enabled device to transfer funds to another party. In an alternative exemplary embodiment, the communications service module 129 may enable the financial payment system 120 using dual-tone multi-frequency (DTMF), also known as touch tone technology used for telephone signaling over the line in the voice frequency band, to facilitate the transfer of funds.

The communications network 105 may be a wireless communications (e.g., a cellular communications network, etc) and/or a wired communications network (e.g., a land-line connected to a public branch exchange system (PBX), etc.).

It is understood that the system 100 is not limited to the components disclosed in FIG. 1. Rather, system 100 may include additional components such as a cellular base tower or a PBX, to relay communications, and various other carrier communications infrastructures that are not described in detail here in order not to obscure the detailed description.

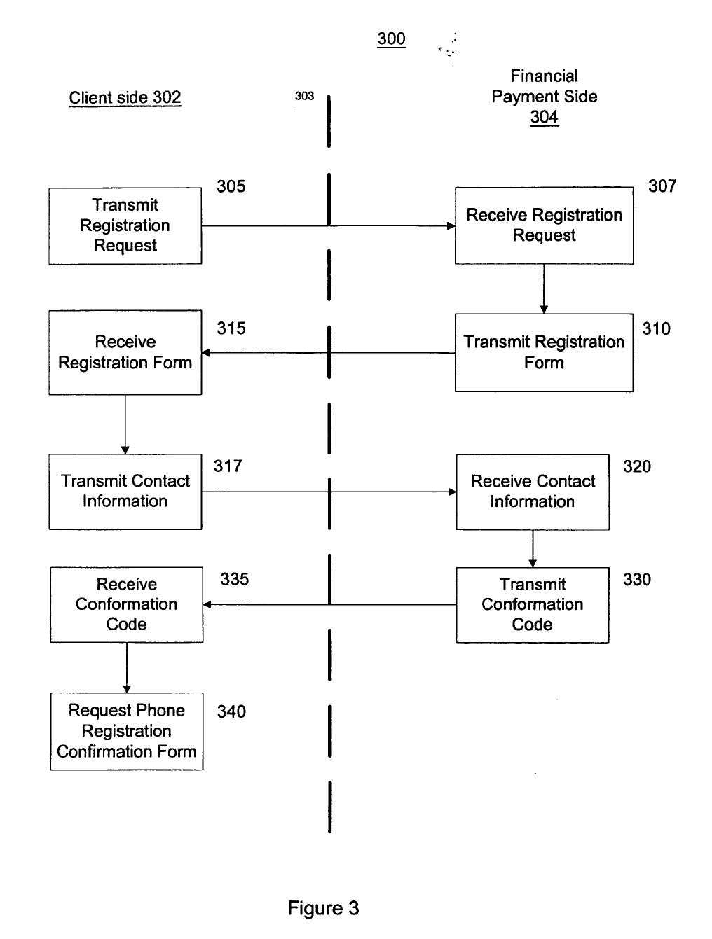

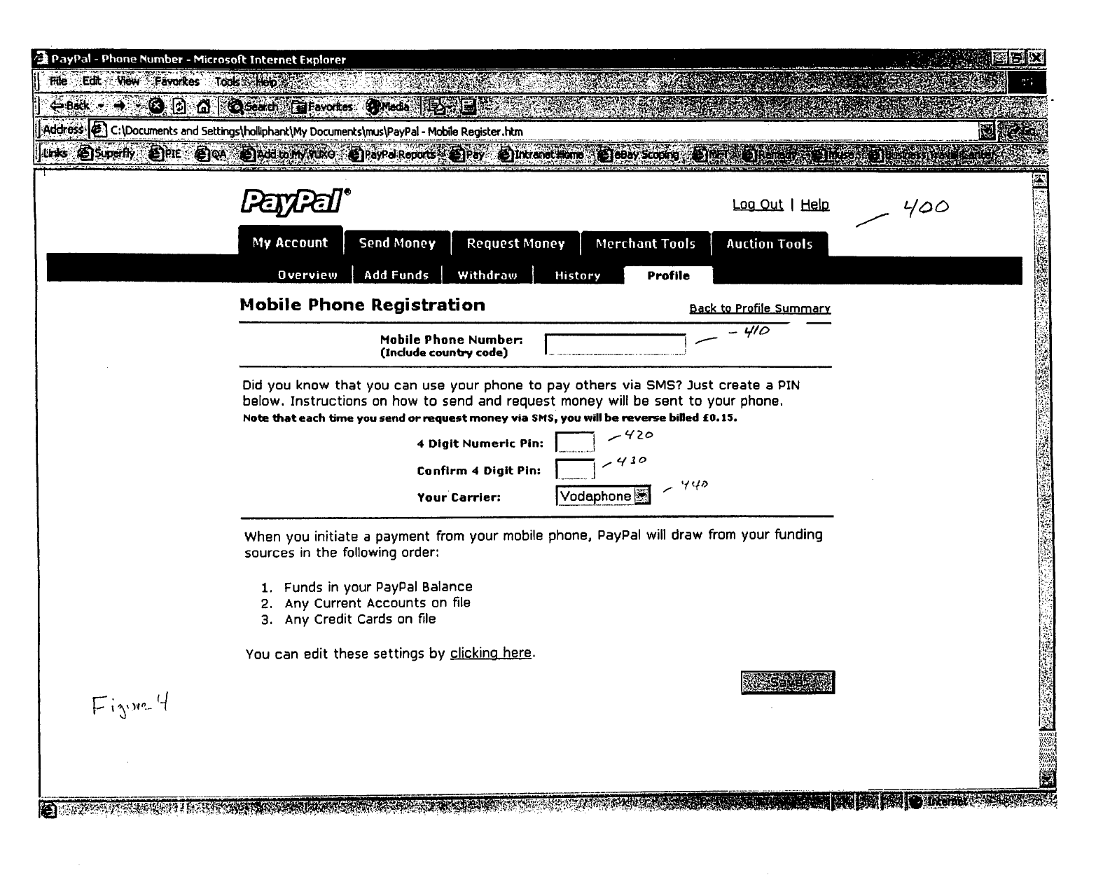

FIG. 3 illustrates one embodiment of an exemplary registration process flow 300 for configuring the financial payment system 120 to facilitate a transfer of funds from one or more financial accounts associated with a user using a telephone-enabled device. In this fashion, the financial payment system 120 is configured to associate a specific client device (e.g., a mobile phone) with one or more financial accounts associated with a specific user. FIG. 3 illustrates the process flow of a client side 302 and a financial payment system side 304 by line 303.

At block 305, client device 150 transmits a request to register with the financial payment system 120 to configure one or more financial accounts to a specific user. The user might transmit this request after accessing a personal profile associated with the user on the financial payment system 120 over a network, using authentication information (e.g., user identifier and password). In this fashion, the financial payment system 120 may store the necessary information to register the user within a record (e.g., a financial data structure) associated with this user. For example, the client device 150 might transmit the registration request using a web-browser connecting with the financial payment system 120 using a hypertext transfer protocol secure (HTTPs), hypertext transfer protocol (HTTP), a wireless application protocol (WAP), among other examples well known to those of ordinary skill in the art.

At block 307, the financial payment system 120 receives the registration request.

At block 310, the financial payment system 120 transmits a registration form to client device 150 to collect contact information necessary for registration. For example, the contact information may be a phone number or an electronic mail address, each associated with a client device to be registered.

At block 315, the client device 150 receives the registration form. For example, FIG. 4 illustrates one embodiment of a Phone Registration Form 400 that may be used to collect contact information to register a mobile telephone to be used by the user to facilitate a transfer of funds, as will be further described below. The Phone Registration Form 400 prompts the user to enter the phone number associated with the mobile telephone device to be registered into the phone number field 410. For example, the user may insert the phone number associated with the client device 150 into the phone number field 410. The Phone Registration Form 400 also enables a user to specify a PIN number, a PIN number confirmation, and a name of the carrier associated with the registered phone into a PIN field 420, a Confirm PIN field 430, and Carrier field 440, respectively. The information from fields 420, 430, and 440 may be used to authenticate a user.

At block 317, the client device 150 transmits the contact information to the financial payment system 120.

At block 320, the financial payment system 120 receives the contact information. In one embodiment, the contact information is stored in the datastore 125 within the user identifier field 210.

At block 330, the financial payment system 120 transmits a confirmation code to the registered client device. For example, the financial payment system 120 generates a confirmation code to the registered client device 150 with a request for the user of the registered client device to confirm the registration of the device.

At block 335, the registered client device 150 receives the confirmation code. The user of the registered client device 150 may view the confirmation code via the display 115.

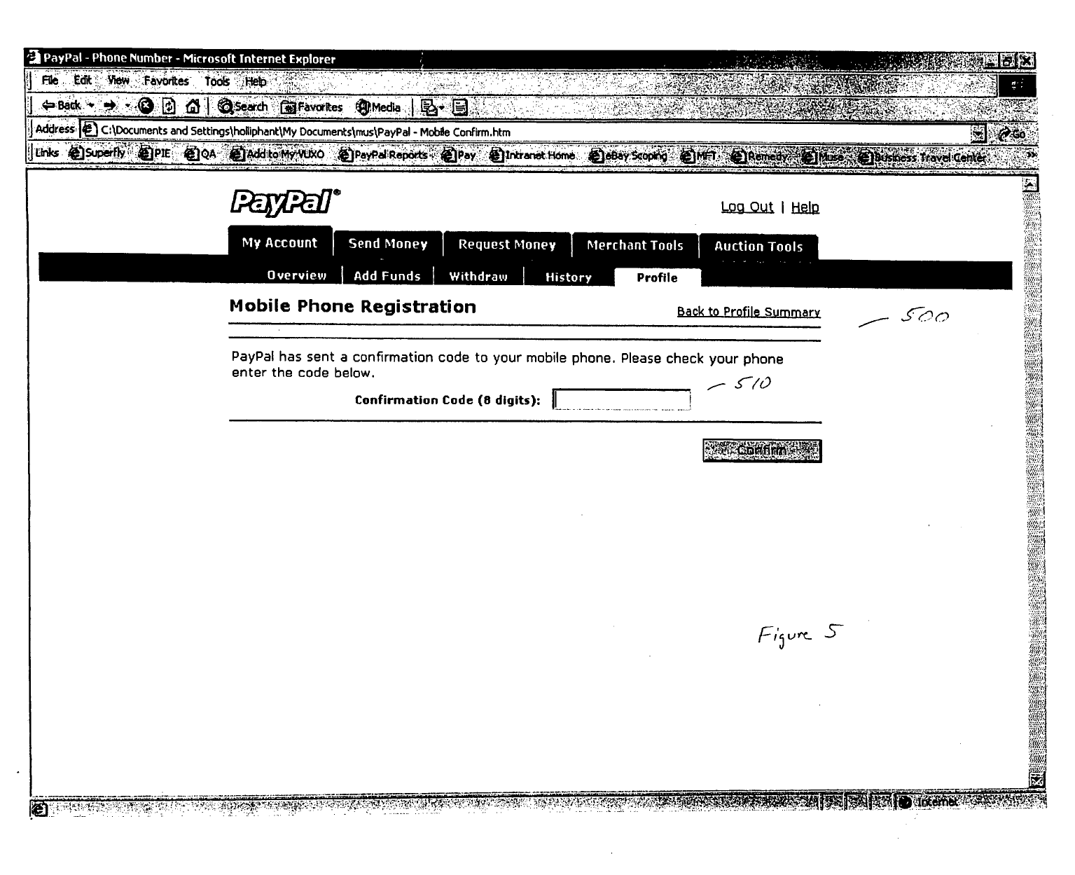

At block 340, the client device 150 requests a Phone Registration Confirmation Form from the financial payment system 120. For example, FIG. 5 illustrates one embodiment of an exemplary Phone Registration Confirmation Form 500. The user may insert the confirmation code received from the registered client device 150 into the Confirmation Code field 510. In this fashion, the financial payment system 120 confirms the user associated with the accessed financial current account is likewise associated with the registered client device 150.

In this fashion, the financial payment system 120 is configured to communicate with the registered telephone-enabled device, for example, to receive instructions regarding a transfer of funds to the financial account of another party (e.g., an individual or merchant).

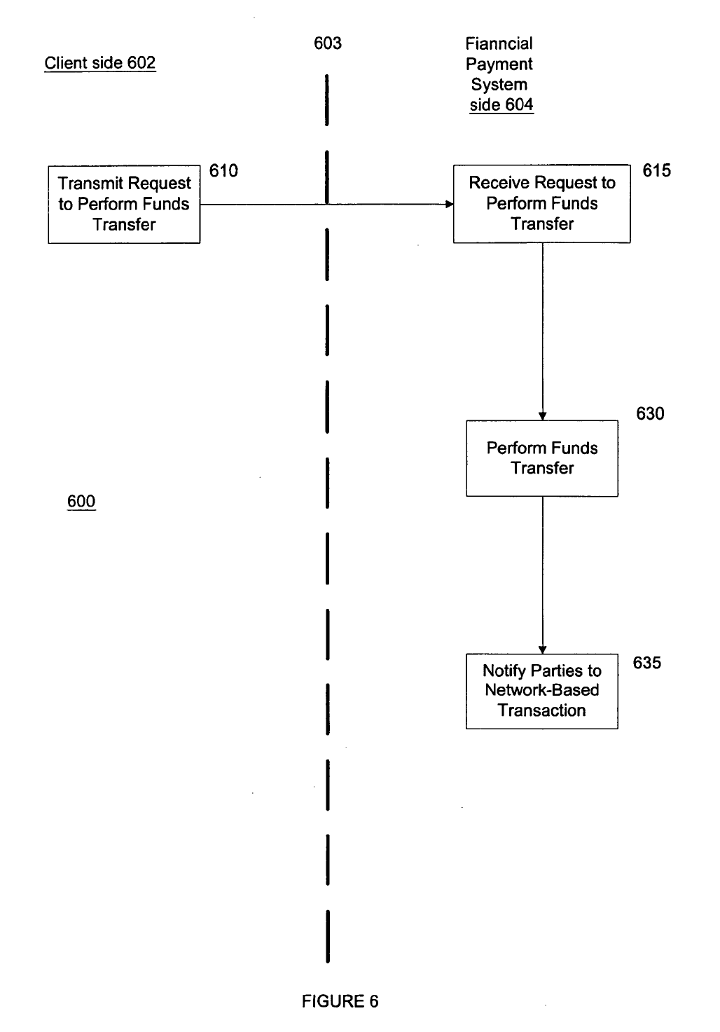

FIG. 6 illustrates one embodiment of a process flow 600 for facilitating a funds transfer between parties using a telephone-enabled device. FIG. 6 illustrates the process flow of a client side 602 and a financial payment system side 604 by line 603.

At block 610, a user using a client device 110 transmits a request to perform a transfer of funds to the financial payment system 120. The request includes transaction information such as a transfer amount and an identifier of a second party as will be described. As stated above, the user may communicate with the financial payment system 120 using various methods. For example, the user might use the display 115 and the alpha-numeric input 117 to transmit a text message instructing the financial payment system 120 to transfer the given transfer amount from a financial account associated with the first party to a financial account associated with the second party.

The identifier of the second party might include an electronic mail address (e.g., e-mail address), or a phone number associated with the second party. It is understood that the transaction information is not limited to the information described herein but might include additional information such as a PIN number that might be used to authenticate the party requesting the funds transfer.

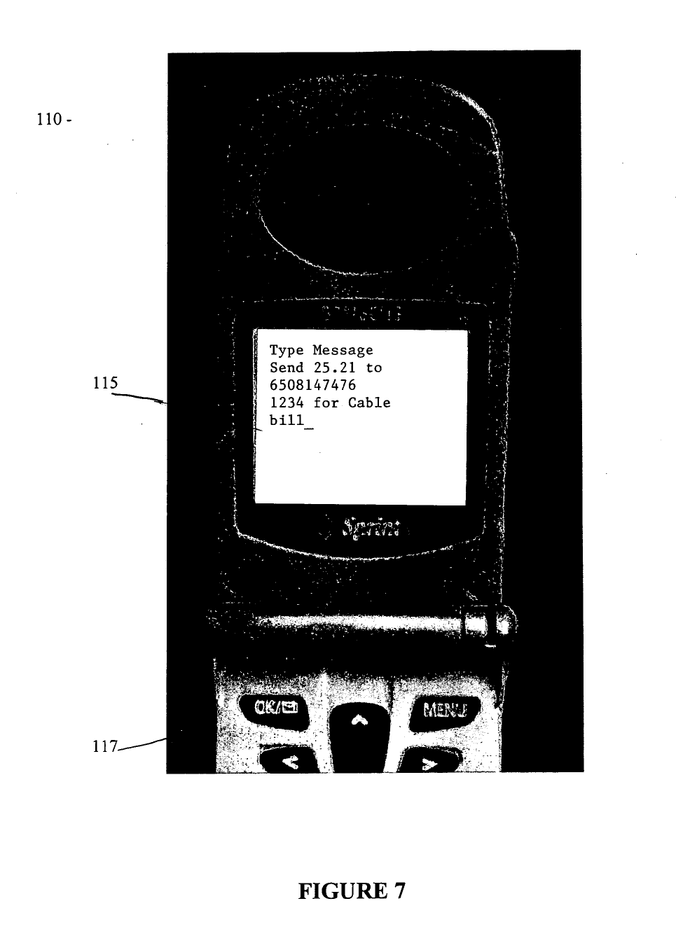

FIG. 7 illustrates an exemplary view of the client device 110 that might be used to request a funds transfer. The client device 110 includes a display 115 and the alphanumeric input 117. FIG. 7 illustrates one exemplary embodiment of the syntax of the text message using client device 110. For example, the user of the client device 110 types “send 25.21 to 6508147476” to initiate a funds transfer of $25.21 to a second user associated with the phone number (650) 814-7476.

At block 615, the financial payment system 120 receives the transaction information.

At block 630, the financial payment system 120 performs the requested transfer of funds from the financial account associated with the first party to the financial account associated with the second party identifier. It is understood that the financial payment system 120 may first request confirmation from the second party before performing the funds transfer. For example, if the transaction information received includes authentication information (e.g., a PIN), the financial payment system 120 will authenticate the transfer request prior to transferring the funds. Furthermore, the financial payment system 120 might also notify the counter-party via electronic mail or a phone call and request authorization prior to performing the funds transfer. However, it is also understood that the financial payment system 120 might transfer the funds upon receiving the request automatically without further human intervention.

In addition, it is understood that the financial accounts may or may not be financial accounts managed by the financial payment system 120. For example, the financial payment system 120 might facilitate a transfer of funds between financial accounts managed by the financial payment system 120 (e.g., for example, the payment system is a system similar to Paypal, a division of eBay Inc.), and also facilitate a funds transfer with third party financial institutions, such as banks and credit card companies, or a combination thereof.

At block 635, the financial payment system 120 notifies both parties of the completion of the funds transfer.

Thus, a method and system to facilitate the transfer of funds between parties using a telephone-enabled device has been described. It should be noted that the financial payment system 120 might be used to exchange funds between parties such as an individual (e.g., street vendor, cab driver, etc) and merchants (e.g., a department store, an online merchant, etc.). The financial payment system 120 might also be used to request funds from a counter-party. For example, upon receiving a request to transfer funds to a party, the user may transfer funds to the requesting user as illustrated by example in process flow 600.

### Alternative Platform Architecture

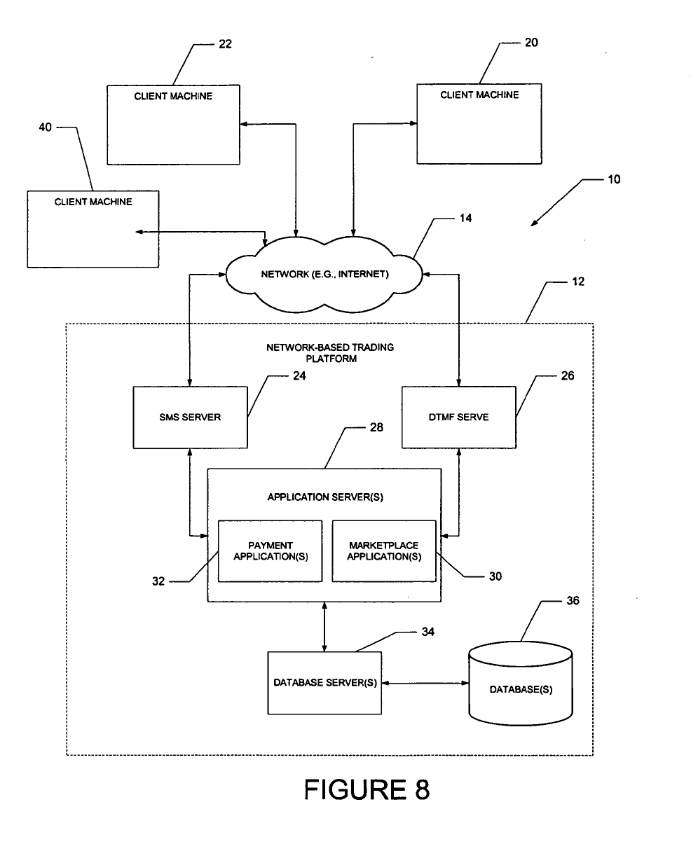

FIG. 8 is a network diagram depicting an alternative system 10, according to another exemplary embodiment of the present invention. A commerce platform, in the exemplary form of a network-based marketplace 12, provides server-side functionality, via a network 14 (e.g., a plain old telephone network, fiber optics network, the Internet, etc.) to facilitate the transfer of funds between parties using telephone-enabled client devices (20, 22, 40).

Turning specifically to the network-based marketplace 12, a SMS service 24 and a DTMF service 26 are coupled to, and provide SMS and DTMF interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the network-based marketplace 12. The payment applications 32 likewise, provide a number of payment services and functions to users. The payment applications 32 may allow users to quantify for, and accumulate value (e.g., in a commercial currency, such as the U.S. dollar, or a proprietary currency, such as “points”) in accounts, and then later redeem the accumulated value for products (e.g., goods or services) that are made available via the marketplace applications 30. As will be described, the payment applications 32 might also be used by the user to transfer funds to one or more parties using the telephone-enabled devices 20, 22, and 40. While the marketplace and payment applications 30 and 32 are shown in FIG. 8 to both form part of the network-based marketplace 12, it will be appreciated that, in alternative embodiments of the present invention, the payment applications 32 may form part of a payment service that is separate and distinct from the network-based marketplace 12.

Further, while the system 10 shown in FIG. 8 employs a client-server architecture, the present invention is of course not limited to such an architecture, and could equally well find applications in a distributed, or peer-to-peer, architecture system. The various marketplace and payment applications 30 and 32 could also be implemented as standalone software programs, which do not necessarily have networking capabilities.

### Marketplace Applications

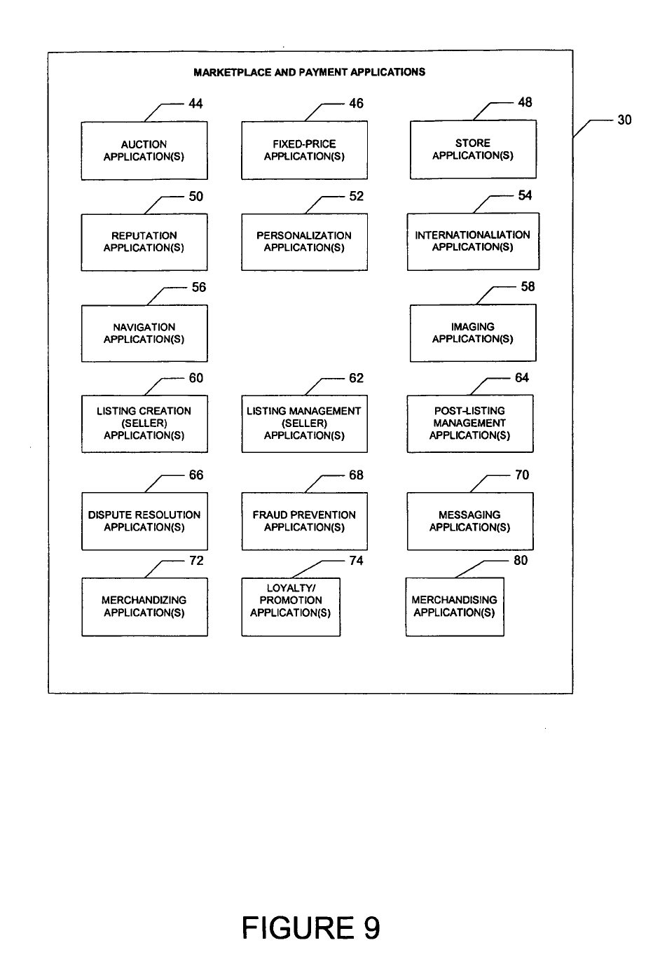

FIG. 9 is a block diagram illustrating multiple marketplace and payment applications 30 and 32 that, in one exemplary embodiment of the present invention, are provided as part of the network-based marketplace 12. The marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allows sellers to group their listings within a “virtual” store, which may be branded and otherwise personalized by and for the sellers. Such a virtual store may also offer promotions, incentives and features that are specific and personalized to a relevant seller.

Reputation applications 50 allows parties that transact utilizing the network-based marketplace 12 to establish, build and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allows a user, for example, through feedback provided by other transaction partners, to establish a reputation within the network-based marketplace 12 over time. Other potential trading partners may then reference such a reputation for the purposes of assessing credibility and trustworthiness.

Personalization applications 52 allows users of the network-based marketplace 12 to personalize various aspects of their interactions with the network-based marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the network-based marketplace 12 and other parties.

In one embodiment, international applications 54 allows users of the network-based marketplace 12 to support a number of marketplaces that are customized, for example, for specific geographic regions. A version of the network-based marketplace 12 may be customized for the United Kingdom, whereas another version of the network-based marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the network-based marketplace 12. A browse application allows users to browse various categories, catalogues, or inventory data structures according to which listings may be classified within the network-based marketplace 12. Various other navigation applications may be provided to supplement the search and browsing applications.

In order to make listings available via the network-based marketplace 12, as visually informing and attractive as possible, the marketplace applications 30 may include one or more imaging applications 58 which users may utilize to upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allows sellers to conveniently author listings pertaining to goods or services that they wish to transact via the network-based marketplace 12, and listing management applications 62 allows sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller to conveniently provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the network-based marketplace 12.

Messaging applications 70 are responsible for the generation and delivery of messages to users of the network-based marketplace 12, such messages for example advising users regarding the status of listings at the network-based marketplace 12 (e.g., providing “outbid” notices to bidders during an auction process or to provide promotional and merchandising information to users).

Merchandising applications 72 support various merchandising functions that are made available to sellers to enable sellers to increase sales via the network-based marketplace 12. The merchandising applications 80 also operate the various merchandising features that may be invoked by sellers, and may monitor and track the success of merchandising strategies employed by sellers.

The network-based marketplace 12 itself, or one or more parties that transact via the network-based marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

It should be understood that the marketplace and payment applications 30 and 32 might also include the funds transfer module 127 as described above.

### Data Structures

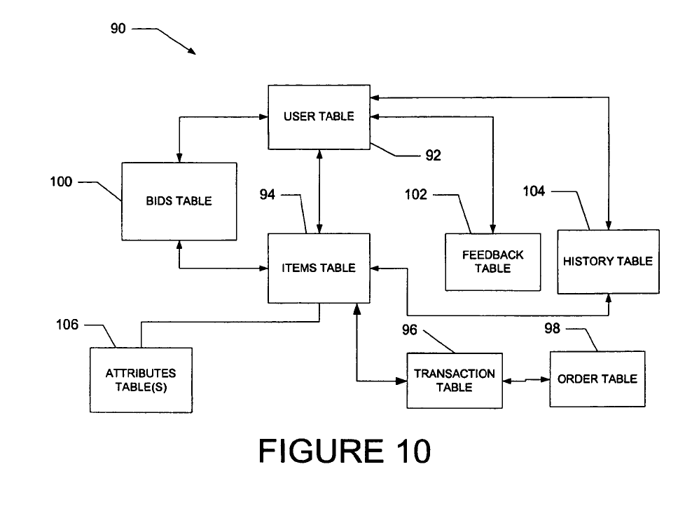

FIG. 10 is a high-level entity-relationship diagram, illustrating various tables 90 that may be maintained within the databases 36, and that are utilized by and support the marketplace and payment applications 30 and 32. A user table 92 contains a record for each registered user of the network-based marketplace 12, and may include identifiers, such as address and financial instrument information pertaining to each such registered user. A user may, it will be appreciated, operate as a seller, a buyer, or both, within the network-based marketplace 12. In one exemplary embodiment of the present invention, a buyer may be a user that has accumulated value (e.g., commercial or proprietary currency), and is then able to exchange the accumulated value for items that are offered for sale by the network-based marketplace 12.

The tables 90 also include an items table 94 in which are maintained item records for goods and services that are available to be, or have been, transacted via the network-based marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in one exemplary embodiment, to construct and maintain reputation information concerning users. A history table 104 maintains a history of transactions to which a user has been a party. One or more attributes tables 106 records attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

The tables 90 also includes a financial account table (not shown) having fields similar to the financial account data structure 250 as described above.

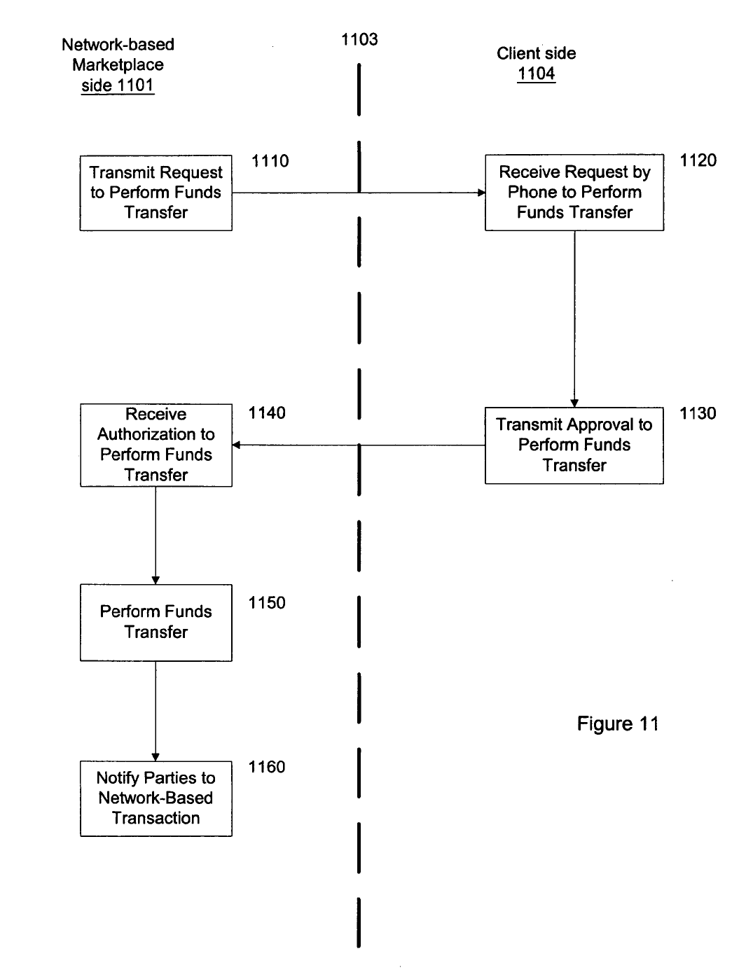

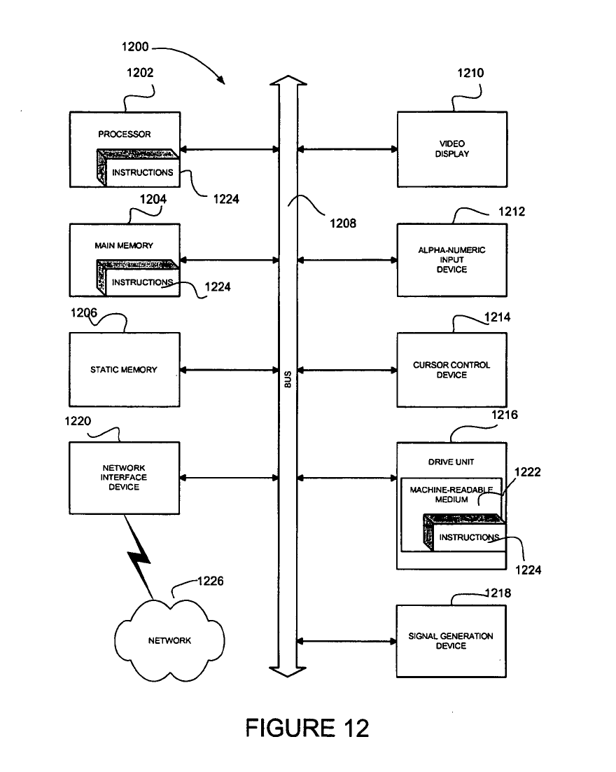

FIG. 11 illustrates an exemplary embodiment of a process flow for performing a transfer of funds upon completion of a network-based transaction. FIG. 11 illustrates the process flow of a client side 1104 and a network-based transaction side 1101 by line 1103.

At block 1110, the network-based marketplace 12 transmits a transfer funds request to a user associated with a network-based transaction. The funds transfer request might include transaction information such as a transaction code, a description of the network-based transaction, and the transaction amount. For example, the network-based marketplace 12 may transmit the request to a mobile phone of a buyer automatically upon completion of an auction. In another example, upon entering the necessary sales information into a cash register terminal, the network-based marketplace 12 may transmit the funds transfer request to the mobile phone associated with the buyer.

At block 1120, the client device 20 receives the request to transfer funds associated with the network-based transaction. For example, the client device 20 might be a mobile telephone that receives a text message indicating the user of the client device 20 has won an auction and request whether the user would prefer to pay for the listing via a funds transfer.

At block 1130, the client device transmits authorization to perform the funds transfer associated with the network-based transaction. In one embodiment, the user might also specify the financial account to transfer the funds from.

At block 1140, the network-based marketplace 12 receives the authorization to perform the funds transfer associated with the transaction. For example, if the user transmits the authorization via an SMS message, the SMS server 24 will receive the message. If the user transmits the authorization via a DTMF tone, the DTMF server 26 will receive the message.

At block 1150, the network-based marketplace 12 performs the transfer of funds associated with the network-based transaction.

At block 1160, the network-based marketplace 12 notifies the parties associated with the network-based transaction. For example, the network-based marketplace 12 may facilitate the notification to both the buyer and seller in an auction associated with the network-based transaction of the transfer of funds. In another example, the network-based marketplace 12 might inform a sales clerk via a networked cash register terminal of the transfer of funds.

It will be appreciated that more or fewer processes may be incorporated into the method illustrated in FIGS. 3, 6, and 11 without departing from the scope of an embodiment of the invention and that no particular order is implied by the arrangement of blocks shown and described herein. It further will be appreciated that the method described in conjunction with FIGS. 3, 6, and 11 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The method may be provided as a computer program product that may include a machine-readable medium having stored thereon instructions that may be used to program a computer (or other electronic devices) to perform the method. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and a carrier wave that encodes a data signal. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

FIG. 12 shows a diagrammatic representation of a machine in the exemplary form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processor 1202 (e.g., a central processing unit (CPU), a graphics processing unit (GPU), or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of instructions (e.g., software 1224) embodying any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

The software 1224 may further be transmitted or received over a network 1226 via the network interface device 1220.

While the machine-readable medium 1222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to facilitate a transfer of funds between parties using a telephone-enabled device have been described. Although the present invention has been described with reference to specific exemplary embodiments, it will be evident that various modifications and changes may be made to these embodiments without departing from the broader spirit and scope of the invention. For example, in alternative embodiments the methods described herein may be implemented on a client device using a web browser application. For instance, the client devices might be used to render the information described using a web browser application with compact-hypertext markup language (cHTML), wireless markup language (WML), handheld device markup language (HDML), and human machine language (MML), and extensible hypertext markup language (xHTML), among other languages well known to those of ordinary skill in the art. Accordingly, the specification and drawings are to be regarded in an illustrative rather than a restrictive sense.

What is claimed is:

1. A method comprising:
receiving, over a network, a registration request to register a mobile telephone with a financial payment system, the registration request for a first financial account on the financial payment system, the registration of the mobile telephone system to facilitate a transfer of funds;
receiving, over a network at the financial payment system, contact information that identifies the mobile telephone;
generating a confirmation code responsive to receiving the contact information;
communicating, over a network, the confirmation code to the mobile telephone based on the contact information;
receiving, over a network, from the mobile telephone a request to confirm the registration, the request to confirm registration including the confirmation code; and
configuring the first financial account at the financial payment system to receive instructions from the mobile telephone to transfer funds on the financial payment system.

2. The method of claim 1, wherein the receiving the registration request includes receiving the registration request from a first client device and wherein the receiving the contact information includes receiving the contact information from the first client device.

3. The method of claim 1, wherein the contact information includes a telephone number for the mobile telephone.

4. The method of claim 1, wherein the contact information includes a personal identification number (PIN).

5. The method of claim 1, wherein the contact information includes a name of telephone carrier.

6. The method of claim 1, further including receiving instructions from the mobile telephone to transfer funds from the first financial account to a second financial account.

7. The method of claim 6, wherein the funds are transferred from a first credit card that is associated with the first financial account to the second financial account.

8. The method of claim 2, wherein the first client device is selected from a group of client devices including a personal digital assistant, a personal computer, the mobile telephone and a second mobile telephone.

9. The method of claim 1, wherein the first financial account is registered to a first user.

10. A financial payment system comprising:
at least one processor; and
logic in memory that is executable by the at least one processor to cause the financial payment system to receive a registration request, over a network, to register a mobile telephone with a financial payment system, the registration request for a first financial account on the financial payment system, the registration of the mobile telephone system to facilitate a transfer of funds, the logic to further cause the financial payment system to receive contact information that identifies the mobile telephone, generate a confirmation code responsive to receiving the contact information, communicate the confirmation code to the mobile telephone based on the contact information, receive from the mobile telephone a request to confirm the registration, the request to confirm registration including the confirmation code, the logic to further cause the financial payment system to configure the first financial account at the financial payment system to receive instructions from the mobile telephone to transfer funds on the financial payment system.

11. The financial payment system of claim 10, wherein the logic is to further cause a receipt of the registration request from a first client device and wherein the logic is to further cause a receipt of contact information from the first client device.

12. The financial payment system of claim 10, wherein the contact information includes a telephone number for the mobile telephone.

13. The financial payment system of claim 10, wherein the contact information includes a personal identification number (PIN).

14. The financial payment system of claim 10, wherein the contact information includes a name of telephone carrier.

15. The financial payment system of claim 10, wherein the logic is to cause the financial payment system to receive instructions from the mobile telephone to transfer funds from the first financial account to a second financial account.

16. The financial payment system of claim 15, wherein the funds are transferred from a first credit card that is associated with the first financial account to the second financial account.

17. The financial payment system of claim 10, wherein the first client device is selected from a group of client devices including a personal digital assistant, a personal computer, the mobile telephone and a second mobile telephone.

18. The financial payment system of claim 10, wherein the first financial account is registered to a first user.

19. A financial payment system comprising:
at least one processor; and
a means in memory for receiving a registration request, over a network, to register a mobile telephone with a financial payment system, the registration request for a first financial account on the financial payment system, the registration of the mobile telephone system to facilitate a transfer of funds, the means for receiving contact information that identifies the mobile telephone, generating a confirmation code responsive to receiving the contact information, communicating the confirmation code to the mobile telephone based on the contact information, receiving from the mobile telephone a request to confirm the registration, the request to confirm registration including the confirmation code, the means for configuring the first financial account at the financial payment system to receive instructions from the mobile telephone to transfer funds on the financial payment system.

20. A machine-readable medium having instructions to cause a machine to perform a method, the method including:
receiving a registration request, over a network, to register a mobile telephone with a financial payment system, the registration request for a first financial account on the financial payment system, the registration of the mobile telephone system to facilitate a transfer of funds;
receiving, at the financial payment system, contact information that identifies the mobile telephone;
generating a confirmation code responsive to receiving the contact information;
communicating the confirmation code to the mobile telephone based on the contact information;
receiving from the mobile telephone a request to confirm the registration, the request to confirm registration including the confirmation code; and
configuring the first financial account at the financial payment system to receive instructions from the mobile telephone to transfer funds on the financial payment system.

21. The machine-readable medium of claim 20, wherein the receiving the registration request includes receiving the registration request from a first client device and wherein the receiving the contact information includes receiving the contact information from the first client device.

22. The machine-readable medium of claim 20, wherein the contact information includes a telephone number for the mobile telephone.

23. The machine-readable medium of claim 20, wherein the contact information includes a personal identification number (PIN).

24. The machine-readable medium of claim 20, wherein the contact information includes a name of telephone carrier.

25. The machine-readable medium of claim 20, further including receiving instructions from the mobile telephone to transfer funds from the first financial account to a second financial account.
